(19) United States
(12) Patent Application Publication
(10) Pub. No.: US 2014/0236936 A1
(43) Pub. Date: Aug. 21, 2014

(54) MATCHING METHOD AND SYSTEM FOR AUDIO CONTENT

(71) Applicant: TENCENT TECHNOLOGY (SHENZHEN) COMPANY LIMITED, Shenzhen (CN)

(72) Inventor: Lifu YI, Shenzhen (CN)

(73) Assignee: TENCENT TECHNOLOGY (SHENZHEN) COMPANY LIMITED, Shenzhen (CN)

(21) Appl. No.: 14/263,371

(22) Filed: Apr. 28, 2014

Related U.S. Application Data
(63) Continuation of application No. PCT/CN2014/070406, filed on Jan. 9, 2014.

(30) Foreign Application Priority Data
Feb. 1, 2013 (CN) 201310039220.0

(51) Int. Cl. G06F 17/30

(52) U.S. Cl. CPC G06F 17/30743
USPC 707/723; 707/758

(57) ABSTRACT

A matching method and system for audio content, includes: obtaining a first audio frame and a second audio frame from an audio clip to be matched, wherein the first audio frame and the second audio frame are audio frames in successive; converting the first audio frame into a first group of sub-bands and converting the second audio frame into a second group of sub-bands; converting the first group of sub-bands into a first group of sub-hash tables and converting the second group of sub-bands into a second group of sub-hash tables; separately comparing the first group of sub-hash tables and the second group of sub-hash tables with the audio clips stored in a database and obtaining a first group of candidate audio and a second group of candidate audio; determining a matching result by selecting from the first group of candidate audio and the second group of candidate audio.

### CROSS REFERENCE TO RELATED APPLICATIONS

This application is a U.S. continuation application under U.S.C. §111(a) claiming priority under U.S.C. §§120 and 365(c) to International Application No. PCT/CN2014/070406, filed on Jan. 9, 2014, which claims the priority benefit of Chinese Patent Application No. 201310039220.0 entitled “MATCHING METHOD AND SYSTEM FOR AUDIO CONTENT” and filed on Feb. 1, 2013, the contents of which are hereby incorporated in their entireties by reference.

### FIELD OF THE TECHNICAL

The present disclosure relates to audio technical field, and more particularly, to a matching method and an audio content matching system.

### BACKGROUND

When television or radio is broadcasting songs, if a person listens to his favorite or interested song, he usually wants to know the name of the song. Audio fingerprinting is a technology to obtain the names of the songs and includes the steps of: obtaining an audio signal of the song broadcasting on the television or radio; processing the audio signal of the song; and comparing the processed audio signal with prestored songs in a database to ultimately obtain the name of the song playing on the television or radio.

However, there are more and more processed audio signals of the songs left in the system, easily resulting in redundant data, and the matching result of only a single audio clip is obtained, which easily causes matching errors.

### SUMMARY

Exemplary embodiments of the present invention provide a matching method and a matching system for audio content, which can solve system burden caused by data redundancy and the matching error problems in the existing technology.

According to a first aspect of the invention, it provides a matching method for audio content, the method includes:

obtaining a first audio frame and a second audio frame from an audio clip to be matched, wherein the first audio frame and the second audio frame are audio frames in successive;

converting the first audio frame into a first group of sub-bands and converting the second audio frame into a second group of sub-bands;

converting the first group of sub-bands into a first group of sub-hash tables and converting the second group of sub-bands into a second group of sub-hash tables;

separately comparing the first group of sub-hash tables and the second group of sub-hash tables with the audio clips stored in a database and obtaining a first group of candidate audio and a second group of candidate audio; and

determining a matching result by selecting from the first group of candidate audio and the second group of candidate audio.

According to a second aspect of the invention, it provides an audio content matching system, comprising:

an audio frame obtaining unit, configured to obtain a first audio frame and a second audio frame from an audio clip to be matched, wherein the first audio frame and the second audio frame are audio frames in successive;

a sub-band converting unit, configured to separately convert the first audio frame and the second audio frame from the audio frame unit into a first group of sub-bands and a second group of sub-bands;

a sub-hash table converting unit, configured to separately convert the first group of sub-bands and the second group of sub-bands from the sub-bands converting unit into a first group of sub-hash tables and a second group of sub-hash tables;

a candidate audio obtaining unit, configured to separately compare the first group of sub-hash tables and the second group of sub-hash tables of the sub-hash table converting unit with the audio clips stored in a database and obtain a first group of candidate audio and a second group of candidate audio; and

a matching result selecting unit, configured to determine a matching result by selecting from the first group of candidate audio and the second group of candidate audio.

According to a third aspect of the invention, it provides a non-transitory computer readable storage medium, storing one or more programs for execution by one or more processors of a computer having a display, the one or more programs comprising instructions for:

obtaining a first audio frame and a second audio frame from an audio clip to be matched, wherein the first audio frame and the second audio frame are audio frames in successive;

converting the first audio frame into a first group of sub-bands and converting the second audio frame into a second group of sub-bands;

converting the first group of sub-bands into a first group of sub-hash tables and converting the second group of sub-bands into a second group of sub-hash tables;

separately comparing the first group of sub-hash tables and the second group of sub-hash tables with the audio clips stored in a database and obtaining a first group of candidate audio and a second group of candidate audio; and

determining a matching result by selecting from the first group of candidate audio and the second group of candidate audio.

In the embodiments of the invention, the audio clips to be matched are divided into sub-bands, and after the sub-bands are carried out wavelet transform, the coefficients of the sub-bands with the highest energy. By means of the position sensitive hash algorithm, the coefficients are converted into a group of sub-hash table, and all the sub-hash tables are saved by means of distributed storage, thereby obtaining matching results of each group of the sub-hash table. The matching results of each group of the sub-hash table are compared with the matching results of a frame of a continuous audio chip, to obtain the final matching result, so that the audio fingerprint is not redundant. In the embodiments of the invention, all the sub-hash tables produced by the position sensitive hash algorithm are saved and at least two frames of continuous audio clips are compared, therefore increasing the accuracy of the matching results.

### BRIEF DESCRIPTION OF THE DRAWINGS

The aforementioned features and advantages of the disclosure as well as additional features and advantages thereof will be more clearly understood hereinafter as a result of a detailed description of preferred embodiment when taken in conjunction with the drawings.

FIG. 1 is a flowchart of a matching method for audio content provided in one embodiment of the present invention; and

FIG. 2 is a block diagram of an audio content matching system provided in one embodiment of the present invention.

### DETAILED DESCRIPTION OF ILLUSTRATED EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In the embodiments of the invention, audio clips to be matched are divided into sub-bands, and after the sub-bands are carried out wavelet transform, coefficients of the sub-bands with the highest energy. By means of position sensitive hash algorithm, the coefficients are converted into a group of sub-hash table, and all the sub-hash tables are saved by means of distributed storage, thereby obtaining matching results of each group of the sub-hash table. The matching results of each group of the sub-hash table are compared with the matching results of a frame of a continuous audio chip, to obtain the final matching result, so that the audio fingerprint is not redundant. In the embodiments of the invention, all the sub-hash tables produced by the position sensitive hash algorithm are saved and at least two frames of continuous audio clips are compared, therefore increasing the accuracy of the matching results.

To illustrate the technical solution of the present disclosure, the following embodiments are used here to by described.

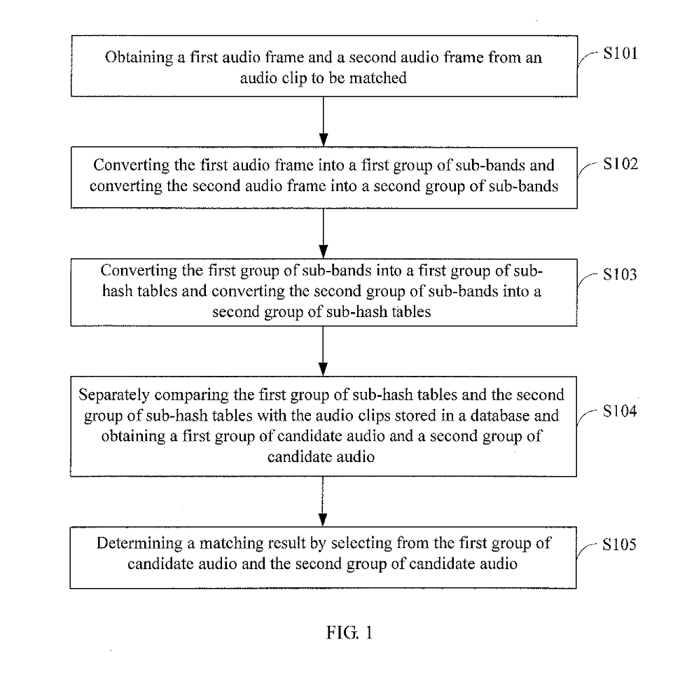

Referring to FIG. 1, FIG. 1 is a flowchart of a matching method for audio content provided in one embodiment of the present invention, and the matching method for audio content includes the following steps.

In step S101, obtaining a first audio frame and a second audio frame from an audio clip to be matched. Wherein the first audio frame and the second audio frame are audio frames in successive.

In this embodiment of the present invention, the audio clip that is broadcasting on the radio is the audio clip to be matched, and at least two audio frames in successive obtained from the audio clip are: the first audio frame and the second audio frame. Here it should be understood that the audio frame to be matched can be a song, and also can be speech, debate and so on. The step of obtaining a first audio frame and a second audio frame from an audio clip to be matched, includes:

(1) separating the audio clip to be matched into successive audio frames by means of sub-frame processing.

In this embodiment of the present invention, the audio clip to be matched is processed and analyzed by means of sub-frame processing with m second(s) interval and n second(s) window length, that is, the length of each audio frame is n second(s), and the interval between every two successive audio frames is m second(s).

(2) obtaining the first audio frame and the second audio frame from the successive audio frames.

In the embodiment of the invention, the first audio frame and the second audio frame are obtained from the successive audio frames. It's should be understood that only the first audio frame and the second audio frame are used here just for the convenience of instructions and descriptions. In the actual calculation, the embodiment can also obtain a third audio frame, a fourth audio frame and more audio frames in order to get a more accurate matching result, but not limited to the first audio frame and the second audio frame.

Moreover, before the step of separating the audio clip to be matched into the successive audio frames by means of sub-frame processing, the method further comprises step of: setting an interval and window length of each audio frame.

In step S102, converting the first audio frame into a first group of sub-bands and converting the second audio frame into a second group of sub-bands.

In this embodiment of the invention, the first audio frame is converted into a first group of sub-bands by the first fast Fourier transform, and the second audio frame is converted into a second group of sub-bands. Thus, in the subsequent steps, the audio fingerprint of the audio clip can be obtained by the first group of sub-bands and the second group of sub-bands, thereby reducing the redundancy of the audio fingerprint in the system.

In step S103, converting the first group of sub-bands into a first group of sub-hash tables and converting the second group of sub-bands into a second group of sub-hash tables.

In this embodiment of the invention, because the audio clip is essentially a signal, so that the signal processing of the audio clip is equivalent to the signal processing of the audio signal. Thus, the audio fingerprints of at least two frames of audio clips can be obtained by the signal processing of the audio clip. The step of converting the first group of sub-bands into a first group of sub-hash tables and converting the second group of sub-bands into a second group of sub-hash tables includes:

(1) separately carrying out wavelet transform for the first group of sub-bands and the second group of sub-bands, and retaining the coefficients of at least two wavelet transforms with the highest energy in the first group of sub-bands and the coefficients of at least two wavelet transforms with the highest energy in the second group of sub-bands, and combining the coefficients of the wavelet transforms with the highest energy in the first group of sub-bands to form a first group of coefficients and combining the coefficients of the wavelet transforms with the highest energy in the second group of sub-bands to form a second group of coefficients.

In the embodiment of the invention, the reason that the first group of sub-bands and the second of sub-bands retain the coefficients of at least two wavelet transforms, because in the subsequent steps, candidate audios are produced according to the coefficients and the candidate audios are compared within each sub-band,

(2) separately carrying out binary translation for the first group of coefficients and the second group of coefficients, and then compressing the first group of coefficients and the second group of coefficients into a first group of sub-fingerprints and a second group of sub-fingerprints based on minimal hash algorithm.

(3) separately converting the first group of sub-fingerprints and the second group of sub-fingerprints into a first group of sub-hash tables and a second group of sub-hash tables based on the position sensitive hash algorithm, and storing the first group of sub-hash tables and the second group of sub-hash tables by means of distributed storage method.

In this embodiment of the invention, the sub-fingerprints are converted into the sub-hash tables based on the position sensitive hash algorithm. However, the position sensitive hash algorithm has a disadvantage, namely, that is, the position sensitive hash algorithm has a relatively narrow value range. Specific to this embodiment, not all sub-hash tables can be stored due to the disadvantage of the position sensitive hash algorithm, so that the distributed storage method is added into this embodiment, to save all the sub-hash tables.

In step S104, separately comparing the first group of sub-hash tables and the second group of sub-hash tables with the audio clips stored in a database and obtaining a first group of candidate audio and a second group of candidate audio.

In this embodiment of the invention, the first group of sub-hash tables and the second group of sub-hash tables are separately compared with the audio clips stored in the database to record identification of the audio clip matching each sub-hash table. The identification includes, but not limited to: name, serial number in the database, and so on. The step of obtaining a first group of candidate audio and a second group of candidate audio can specifically include:

(1) assuming that the first group of sub-hash tables includes: a sub-hash table 1 and a sub-hash table 2. The sub-hash table 1 matches an audio clip 1, an audio clip 2 and an audio clip 3, and the sub-hash table 2 matches the audio clip 2, the audio clip 3 and an audio clip 4, therefore, the matching results of the first group of sub-hash tables are the audio clip 2 and the audio clip 3, namely, the first group of candidate audio includes the audio clip 2 and the audio clip 3.

(2) assuming that the second group of sub-hash tables includes: a sub-hash table 3 and a sub-hash table 4. The sub-hash table 3 matches the audio clip 2, the audio clip 3 and the audio clip 4, and the sub-hash table 4 matches the audio clip 3, the audio clip 4 and an audio clip 5, therefore, the matching results of the second group of sub-hash tables are the audio clip 3 and the audio clip 4, namely, the second group of candidate audio includes the audio clip 3 and the audio clip 4.

In step S105, determining a matching result by selecting from the first group of candidate audio and the second group of candidate audio.

In this embodiment of the invention, the first group of candidate audio and the second group of candidate audio are compared with each other to select the final matching result. The step of selecting the matching result from the first group of candidate audio and the second group of candidate audio can specifically include:

(1) calculating the weight of the same audio in the first group of candidate audio and the second group of candidate audio;

(2) selecting the audio with the highest weight as the matching result.

In the embodiment of the present invention, the first group of candidate audio and the second group of candidate audio are compared with each other, for example, the matching results of the first group of sub-hash tables are the audio clip 2 and the audio clip 3, and the matching results of the second group of sub-hash tables are the audio clip 3 and the audio clip 4, therefore, the final matching result is the audio clip 3. In this embodiment of the invention, weight calculation is an existing calculation method, and can also use different calculation methods based on the actual situation, it is not specifically defined herein.

In the embodiments of the invention, the audio clips to be matched are divided into sub-bands, and after the sub-bands are carried out wavelet transform, the coefficients of the sub-bands with the highest energy. By means of the position sensitive hash algorithm, the coefficients are converted into a group of sub-hash table, and all the sub-hash tables are saved by means of distributed storage, thereby obtaining matching results of each group of the sub-hash table. The matching results of each group of the sub-hash table are compared with the matching results of a frame of a continuous audio chip, to obtain the final matching result, so that the audio fingerprint is not redundant. In the embodiments of the invention, all the sub-hash tables produced by the position sensitive hash algorithm are saved and at least two frames of continuous audio clips are compared, therefore increasing the accuracy of the matching results.

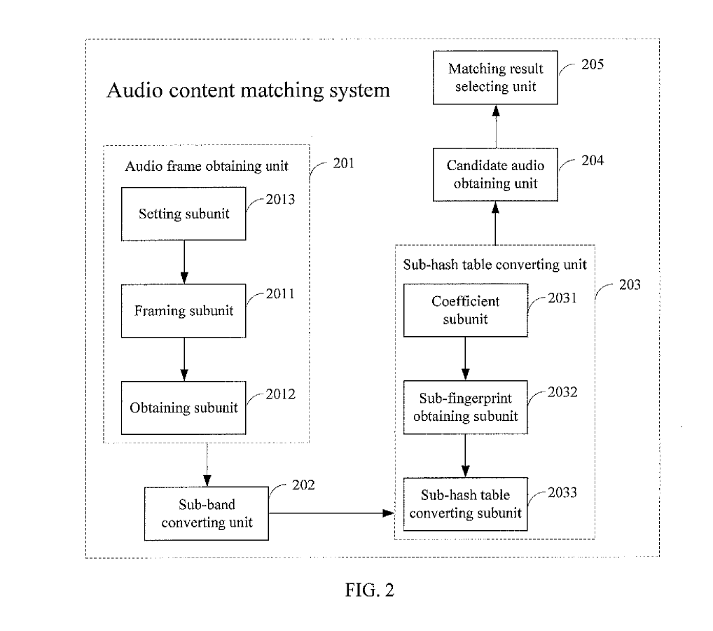

Referring to FIG. 2, FIG. 2 is a block diagram of an audio content matching system provided in one embodiment of the present invention. For easy of illustration and description, the figure only shows the portions related to the embodiment of the present invention. The audio content matching system includes: an audio frame obtaining unit 201, a sub-band converting unit 202, a sub-hash table converting unit 203, a candidate audio obtaining unit 204 and a matching result selecting unit 205.

The audio frame obtaining unit 201, is configured to obtain a first audio frame and a second audio frame from an audio clip to be matched. Wherein the first audio frame and the second audio frame are audio frames in successive.

In this embodiment of the present invention, the audio clip that is broadcasting on the radio is the audio clip to be matched, and the audio frame obtaining unit 201 obtains at least two audio frames in successive from the audio clip: the first audio frame and the second audio frame. The audio frame obtaining unit 201, in detail, includes: a framing subunit 2011 and an obtaining subunit 2012.

The framing subunit 2011 is configured to separate the audio clip to be matched into successive audio frames by means of sub-frame processing.

In this embodiment of the present invention, the framing subunit 2011 processes and analyzes the audio clip to be matched by means of sub-frame processing with m second(s) interval and n second(s) window length, that is, the length of each audio frame is n second(s), and the interval between every two successive audio frames is m second(s).

The obtaining subunit 2012 is configured to obtain the first audio frame and the second audio frame from the framing subunit 2011.

In the embodiment of the invention, the obtaining subunit 2012 can obtain the first audio frame and the second audio frame from the successive audio frames. It's should be understood that only the first audio frame and the second audio frame are used here just for the convenience of instructions and descriptions. In the actual calculation, the embodiment can also obtain a third audio frame, a fourth audio frame and more audio frames in order to get a more accurate matching result, but not limited to the first audio frame and the second audio frame.

In an alternative embodiment of the invention, the audio frame obtaining unit 201 further includes a setting subunit 2013.

The setting subunit 2013 is configured to set an interval and window length of each audio frame.

The sub-band converting unit 202 is configured to separately convert the first audio frame from the first frame unit 201 into a first group of sub-bands, and convert the second audio frame from the audio frame unit 201 into a second group of sub-bands.

In this embodiment of the invention, the sub-band converting unit 202 can convert the first audio frame into the first group of sub-bands by the first fast Fourier transform, and convert the second audio frame into the second group of sub-bands. Thus, in the subsequent steps, the audio fingerprint of the audio clip can be obtained by the first group of sub-bands and the second group of sub-bands, thereby reducing the redundancy of the audio fingerprint in the system.

The sub-hash table converting unit 203 is configured to convert the first group of sub-bands from the sub-bands converting unit 202 into a first group of sub-hash tables, and convert the second group of sub-bands from the sub-bands converting unit 202 into a second group of sub-hash tables.

In this embodiment of the present invention, because the audio clip is essentially a signal, so that the signal processing of the audio clip is equivalent to the signal processing of the audio signal. Thus, the audio fingerprints of at least two frames of audio clips can be obtained by the signal processing of the audio clip. The sub-hash table converting unit 203, in detail, includes: a coefficient subunit 2031, a sub-fingerprint obtaining subunit 2032 and a sub-hash table converting subunit 2033.

The coefficient subunit 2031 is configured to separately carry out wavelet transform for the first group of sub-bands and the second group of sub-bands, and retain the coefficients of at least two wavelet transforms with the highest energy in the first group of sub-bands and the coefficients of at least two wavelet transforms with the highest energy in the second group of sub-bands, and combine the coefficients of the wavelet transforms with the highest energy in the first group of sub-bands to form a first group of coefficients and combine the coefficients of the wavelet transforms with the highest energy in the second group of sub-bands to form a second group of coefficients.

In the embodiment of the invention, the reason that the first group of sub-bands and the second of sub-bands retain the coefficients of at least two wavelet transforms, because in the subsequent steps, candidate audios are produced according to the coefficients and the candidate audios are compared within each sub-band.

The sub-fingerprint obtaining subunit 2032 is configured to separately carry out binary translation for the first group of coefficients and the second group of coefficients from the coefficient subunit 2031, and separately compress the first group of coefficients and the second group of coefficients into a first group of sub-fingerprints and a second group of sub-fingerprints based on minimal hash algorithm.

The sub-hash table converting subunit 2033 is configured to convert the first group of sub-fingerprints from the sub-fingerprint obtaining subunit 2032 into a first group of sub-hash tables, and convert the second group of sub-fingerprints from the sub-fingerprint obtaining subunit 2032 into a second group of sub-hash tables based on the position sensitive hash algorithm, and store the first group of sub-hash tables and the second group of sub-hash tables by means of distributed storage method.

In this embodiment of the invention, the sub-hash table converting unit 2033 can convert the sub-fingerprints into the sub-hash tables based on the position sensitive hash algorithm. However, the position sensitive hash algorithm has a disadvantage, namely, that is, the position sensitive hash algorithm has a relatively narrow value range. Specific to this embodiment, not all sub-hash tables can be stored due to the disadvantage of the position sensitive hash algorithm, so that the distributed storage method is added into this embodiment, to save all the sub-hash tables.

The candidate audio obtaining unit 204 is configured to separately compare the first group of sub-hash tables and the second group of sub-hash tables of the sub-hash table converting unit 203 with the audio clips stored in a database and obtain a first group of candidate audio and a second group of candidate audio.

In this embodiment of the invention, the first group of sub-hash tables and the second group of sub-hash tables are separately compared with the audio clips stored in the database to record identification of the audio clip matching each sub-hash table. The identification includes, but not limited to: name, serial number in the database, and so on. Obtaining a first group of candidate audio and a second group of candidate audio can specifically include:

(1) assuming that the first group of sub-hash tables includes: a sub-hash table 1 and a sub-hash table 2. The sub-hash table 1 matches an audio clip 1, an audio clip 2 and an audio clip 3, and the sub-hash table 2 matches the audio clip 2, the audio clip 3 and an audio clip 4, therefore, the matching results of the first group of sub-hash tables are the audio clip 2 and the audio clip 3, namely, the first group of candidate audio includes the audio clip 2 and the audio clip 3.

(2) assuming that the second group of sub-hash tables includes: a sub-hash table 3 and a sub-hash table 4. The sub-hash table 3 matches the audio clip 2, the audio clip 3 and the audio clip 4, and the sub-hash table 4 matches the audio clip 3, the audio clip 4 and an audio clip 5, therefore, the matching results of the second group of sub-hash tables are the audio clip 3 and the audio clip 4, namely, the second group of candidate audio includes the audio clip 3 and the audio clip 4.

The matching result selecting unit 205 is configured to select the matching result from the first group of candidate audio and the second group of candidate audio.

In this embodiment of the invention, the first group of candidate audio and the second group of candidate audio are compared with each other to select the final matching result. The matching result selecting unit 205 specifically includes: a weighting subunit 2051 and a selecting subunit 2052.

The weighting subunit 2051 is configured to calculate the weight of the same audio in the first group of candidate audio and the second group of candidate audio.

The selecting subunit 2052 is configured to select the audio with the highest weight calculated by the weighting subunit 2051 as the matching result.

In the embodiment of the present invention, the first group of candidate audio and the second group of candidate audio are compared with each other, for example, the matching results of the first group of sub-hash tables are the audio clip 2 and the audio clip 3, and the matching results of the second group of sub-hash tables are the audio clip 3 and the audio clip 4, therefore, the final matching result is the audio clip 3. In this embodiment of the invention, weight calculation is an existing calculation method, and can also use different calculation methods based on the actual situation, it is not specifically defined herein.

In the embodiments of the invention, the audio clips to be matched are divided into sub-bands, and after the sub-bands are carried out wavelet transform, the coefficients of the sub-bands with the highest energy. By means of the position sensitive hash algorithm, the coefficients are converted into a group of sub-hash table, and all the sub-hash tables are saved by means of distributed storage, thereby obtaining matching results of each group of the sub-hash table. The matching results of each group of the sub-hash table are compared with the matching results of a frame of a continuous audio chip, to obtain the final matching result, so that the audio fingerprint is not redundant. In the embodiments of the invention, all the sub-hash tables produced by the position sensitive hash algorithm are saved and at least two frames of continuous audio clips are compared, therefore increasing the accuracy of the matching results.

A person having ordinary skills in the art can understand that each unit included in the embodiment two is divided according to logic function, but not limited to the division, as long as the logic functional units can realize the corresponding function. In addition, the specific names of the functional units are just for the sake of easily distinguishing from each other, but not intended to limit the scope of the present disclosure.

A person having ordinary skills in the art can realize that part or whole of the processes in the methods according to the above embodiments may be implemented by a computer program instructing relevant hardware. The program may be stored in a computer readable storage medium, and executed by at least one processor of a laptop computer, a tablet computer, a smart phone, PDA (personal digital assistant) and other terminal devices. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present disclosure. Any variation or replacement made by persons of ordinary skills in the art without departing from the spirit of the present disclosure shall fall within the protection scope of the present disclosure. Therefore, the scope of the present disclosure shall be subject to be appended claims.

What is claimed is:

1. A matching method for audio content, the method comprising:
obtaining a first audio frame and a second audio frame from an audio clip to be matched, wherein the first audio frame and the second audio frame are audio frames in successive;
converting the first audio frame into a first group of sub-bands and converting the second audio frame into a second group of sub-bands;
converting the first group of sub-bands into a first group of sub-hash tables and converting the second group of sub-bands into a second group of sub-hash tables;
separately comparing the first group of sub-hash tables and the second group of sub-hash tables with the audio clips stored in a database and obtaining a first group of candidate audio and a second group of candidate audio; and
determining a matching result by selecting from the first group of candidate audio and the second group of candidate audio.

2. The method of claim 1, the step of obtaining a first audio frame and a second audio frame from an audio clip to be matched, comprising:
separating the audio clip to be matched into successive audio frames by means of sub-frame processing; and
obtaining the first audio frame and the second audio frame from the successive audio frames.

3. The method of claim 1, the step of converting the first group of sub-bands into a first group of sub-hash tables and converting the second group of sub-bands into a second group of sub-hash tables, comprising:
separately carrying out wavelet transform for the first group of sub-bands and the second group of sub-bands, and retaining coefficients of at least two wavelet transforms with the highest energy in the first group of sub-bands and coefficients of at least two wavelet transforms with the highest energy in the second group of sub-bands, combining the coefficients of the wavelet transforms with the highest energy in the first group of sub-bands to form a first group of coefficients, and combining the coefficients of the wavelet transforms with the highest energy in the second group of sub-bands to form a second group of coefficients;
separately carrying out binary translation for the first group of coefficients and the second group of coefficients, and compressing the first group of coefficients into a first group of sub-fingerprints and compressing the second group of coefficients into a second group of sub-fingerprints based on minimal hash algorithm; and
converting the first group of sub-fingerprints into a first group of sub-hash tables and converting the second group of sub-fingerprints into a second group of sub-hash tables based on position sensitive hash algorithm, and storing the first group of sub-hash tables and the second group of sub-hash tables by means of distributed storage method.

4. The method of claim 2, before the step of separating the audio clip to be matched into successive audio frames by means of sub-frame processing, the method further comprising:
setting an interval and window length of each audio frame.

5. The method of claim 1, the step of selecting the matching result from the first group of candidate audio and the second group of candidate audio, comprising:
calculating a weight of the same audio in the first group of candidate audio and the second group of candidate audio; and
selecting the audio with the highest weight as the matching result.

6. An audio content matching system, comprising:
an audio frame obtaining unit, configured to obtain a first audio frame and a second audio frame from an audio clip to be matched, wherein the first audio frame and the second audio frame are audio frames in successive;
a sub-band converting unit, configured to separately convert the first audio frame and the second audio frame from the audio frame unit into a first group of sub-bands and a second group of sub-bands;
a sub-hash table converting unit, configured to separately convert the first group of sub-bands and the second group of sub-bands from the sub-bands converting unit into a first group of sub-hash tables and a second group of sub-hash tables;
a candidate audio obtaining unit, configured to separately compare the first group of sub-hash tables and the second group of sub-hash tables of the sub-hash table converting unit with the audio clips stored in a database and obtain a first group of candidate audio and a second group of candidate audio; and
a matching result selecting unit, configured to determine a matching result by selecting from the first group of candidate audio and the second group of candidate audio.

7. The audio content matching system of claim 6, wherein the audio frame obtaining unit comprises:
a framing subunit, configured to separate the audio clip to be matched into successive audio frames by means of sub-frame processing; and
a obtaining subunit, configured to obtain the first audio frame and the second audio frame from the framing subunit.

8. The audio content matching system of claim 6, wherein the sub-hash table converting unit, comprises:
a coefficient subunit, configured to separately carry out wavelet transform for the first group of sub-bands and the second group of sub-bands, and retain coefficients of at least two wavelet transforms with the highest energy in the first group of sub-bands and coefficients of at least two wavelet transforms with the highest energy in the second group of sub-bands, combine the coefficients of the wavelet transforms with the highest energy in the first group of sub-bands to form a first group of coefficients, and combine the coefficients of the wavelet transforms with the highest energy in the second group of sub-bands to form a second group of coefficients;
a sub-fingerprint obtaining subunit, configured to separately carry out binary translation for the first group of coefficients and the second group of coefficients from the coefficient subunit, and compress the first group of coefficients into a first group of sub-fingerprints and compress the second group of coefficients into a second group of sub-fingerprints based on minimal hash algorithm; and
a sub-hash table converting subunit, configured to convert the first group of sub-fingerprints from the sub-fingerprint obtaining subunit into a first group of sub-hush tables and convert the second group of sub-fingerprints from the sub-fingerprint obtaining subunit into a second group of sub-hash tables based on position sensitive hash algorithm, and store the first group of sub-hash tables and the second group of sub-hash tables by means of distributed storage method.

9. The audio content matching system of claim 7, wherein the audio frame obtaining unit further comprises:
a setting subunit, configured to set an interval and window length of each audio frame before the framing subunit separates the audio clip to be matched into the successive audio frames by means of sub-frame processing.

10. The audio content matching system of claim 6, wherein the matching result selecting unit, comprises:
a weighting subunit, configured to calculate a weight of the same audio in the first group of candidate audio and the second group of candidate audio; and
a selecting subunit, configured to select the audio with the highest weight calculated by the weighting subunit as the matching result.

11. A non-transitory computer readable storage medium, storing one or more programs for execution by one or more processors of a computer having a display, the one or more programs comprising instructions for:
obtaining a first audio frame and a second audio frame from an audio clip to be matched, wherein the first audio frame and the second audio frame are audio frames in successive;
converting the first audio frame into a first group of sub-bands and converting the second audio frame into a second group of sub-bands;
converting the first group of sub-bands into a first group of sub-hash tables and converting the second group of sub-bands into a second group of sub-hash tables;
separately comparing the first group of sub-hash tables and the second group of sub-hash tables with the audio clips stored in a database and obtaining a first group of candidate audio and a second group of candidate audio; and
determining a matching result by selecting from the first group of candidate audio and the second group of candidate audio.
